(19) United States
(12) Patent Application Publication
(10) Pub. No.: US 2011/0035239 A1
(43) Pub. Date: Feb. 10, 2011

(54) System, method, and computer program product for valuing and administering annuity with guaranteed minimum withdrawal benefit to generate rising withdrawal stream

(75) Inventors: Robert Scheinerman, Woodland Hills, CA (US); Tina Haley, El Segundo, CA (US); Rodney Haviland, Woodland Hills, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AMERICAN INTERNATIONAL GROUP, INC., New York, NY (US)

(21) Appl. No.: 12/697,016

(22) Filed: Jan. 29, 2010

Related U.S. Application Data
(60) Provisional application No. 61/148,622, filed on Jan. 30, 2009.

(51) Int. Cl. G06Q 40/00

(52) U.S. Cl. 705/4

(57) ABSTRACT

Processes, systems, and computer-readable storage media value and administer a variable annuity having a guaranteed minimum withdrawal benefit (GMWB) feature such that an investor can receive a guaranteed rising stream of income. The GMWB feature can be adapted to help create a guaranteed income stream that will last as long as the Covered Person(s) live(s) even if the entire value of the contract has been reduced to zero provided that withdrawals taken are within the parameters of the feature. The GMWB feature can “lock-in” an increased Income Base at the end of a predetermined period that is equal to the greater of (1) actual investment gains on the contract period or (2) an income credit based upon an Income Credit Base, adjusted by withdrawals taken in the prior period. The contract owner may withdraw an amount less than or equal to a Maximum Periodic Withdrawal Amount in each Benefit Period without reducing the Income Base or the Income Credit Base.

### CROSS-REFERENCE TO RELATED APPLICATIONS

This patent application claims the benefit of priority to U.S. Provisional Patent Application No. 61/148,622, filed on Jan. 30, 2009, and entitled “System, Method, and Computer Program Product for Valuing and Administering Annuity With Guaranteed Minimum Withdrawal Benefit To Generate Rising Withdrawal Stream,” which is incorporated in its entirety herein by this reference.

### FIELD OF THE INVENTION

The invention generally relates to a system, method, and computer product for valuing and administering an annuity. More particularly, the invention relates to a system, method, and computer product for valuing and administering an annuity with a guaranteed minimum withdrawal benefit which can guarantee a rising withdrawal stream.

### BACKGROUND OF THE INVENTION

Retirees face certain challenges when managing their assets to generate income. Among them are market volatility, longevity and inflation. Conventional features guarantee protection from market volatility and longevity, but not inflation.

Variable annuity products have been providing guarantees to provide a withdrawal stream for a period of time or for life. These features, often referred to as a guaranteed minimum withdrawal (GMWB) feature, serve to protect investors against market movements (loss in value) and outliving their money. The initial guarantee is generally a fixed percent (4-6% is common) of the investment. Over time and prior to starting withdrawals, this guaranteed amount is adjusted upward for account value growth and downward for withdrawals in excess of a pre-specified amount. In addition, some GMWB features will increase the guaranteed amount by a fixed percent each year without withdrawals and for a set period of time. In years when a withdrawal occurs, investors have the ability to increase their guaranteed withdrawal amount only if the account value increases. As a result, the minimum guarantee will likely be a level income stream for life once withdrawals begin. However, conventional product offerings have not adequately addressed the risk that inflation will negatively impact a retiree's standard of living.

### SUMMARY

This disclosure is directed to processes by which an investor can receive a guaranteed rising stream of income with a variable annuity having a GMWB feature. The methodology provides a simple approach that allows investors to determine how much income they want to withdraw each time period and what level of increase is desired. The processes can be performed using a computing environment and can be embodied in computer readable media bearing instructions for administering an annuity account of an annuitant.

Aspects of the disclosure relate to a system for administering an annuity contract. In one embodiment, a system includes a valuation processor adapted to execute a valuation application for an annuity account of an annuitant. The annuity account has funds allocated to at least one investment. The annuity account has a term including a plurality of periods of time, an account value based upon the value of the funds allocated to at least one investment, an income base for determining a guaranteed benefit, a maximum periodic withdrawal amount in a period that may be withdrawn without affecting the income base, and a minimum periodic increase of the income base.

In this embodiment, a data storage device is provided that contains annuity account information. The data storage device is operably arranged with the valuation processor such that the annuity account information in the storage device is accessible to the valuation processor and is modifiable by the valuation processor.

In this embodiment, the valuation application executed by the valuation processor periodically determines the account value of the annuity; periodically determines the income base using (i) the account value, (ii) the income base with the minimum periodic increase of the income base applied, or (iii) a predetermined combination of the account value and the income base with the minimum periodic increase of the income base applied; and periodically determines the maximum periodic withdrawal amount in a period based upon the income base.

Other aspects of the disclosure relate to a method for administering an annuity account with an increasing income stream. In one embodiment, a method is used with an annuity account having an account value based on funds allocated to at least one investment and a term including a plurality of periods of time.

In this embodiment, an initial income base is established that is independent of the account value. A minimum periodic increase of the income base is established. A maximum periodic withdrawal amount that can be withdrawn in one period without affecting the income base is established. An annuity valuation processor is used to execute a valuation application to determine annuity information for the annuity account. In this embodiment, the valuation application periodically increases the maximum periodic withdrawal amount based upon (i) the account value, (ii) the income base with the minimum periodic increase of the income base applied, or (iii) a predetermined combination of the account value and the income base with the minimum periodic increase of the income base applied.

Other aspects of the disclosure relate to a computer program product for valuing and administering an annuity with a guaranteed minimum withdrawal benefit. In one embodiment, the computer program product comprises a computer-readable storage medium that bears instructions for administering an annuity account of an annuitant. The annuity account has an account value based on funds allocated to at least one investment. The annuity account has a term including a plurality of periods of time, an income base, a minimum periodic increase of the income base, and a maximum periodic withdrawal amount in one period that may be withdrawn without affecting an income base.

In this embodiment, the instructions, when executed by a computer, cause the computer to perform the steps of: setting an initial value for the income base; setting an initial value for the minimum periodic increase of the income base; setting an initial value for the maximum periodic withdrawal amount; periodically determining the value of the annuity based upon the account value of the annuity at the end of the period; periodically determining the income base based upon (i) the periodic value of the annuity, (ii) the income base with the minimum periodic increase of the income base applied, or (iii) a predetermined combination of the periodic value and the income base with the minimum periodic increase of the income base applied; and periodically determining the maximum periodic withdrawal amount based upon the income base.

### BRIEF DESCRIPTION OF THE DRAWINGS

FIG. 1 is an embodiment of a system for valuing and administering an annuity with a guaranteed minimum withdrawal benefit.

FIG. 2 is a flowchart illustrating an embodiment of a process for valuing and administering an annuity with a guaranteed minimum withdrawal benefit.

### DETAILED DESCRIPTION OF EMBODIMENTS OF THE INVENTION

According to the principles of this disclosure, embodiments of a system, a method and a computer program product for valuing and administering an annuity product can allow a user to value and administer an annuity contract having a guaranteed minimum withdrawal feature. At the time of investment, the entity administering the annuity account, such as an insurance company, for example, establishes:
a guaranteed benefit base (e.g., the investment amount);
a structure for increasing the guaranteed benefit base due to increases in account value (e.g., based on AV annually, quarterly, monthly, daily); and
a minimum rate of return prior to beginning withdrawals (increase to the guaranteed benefit base at a set rate of interest, simple or compounded, on a periodic basis, e.g., annually, quarterly, monthly, daily, longer than annually); and
a schedule for withdrawals (e.g., based on the benefit base and the age of the covered person(s) at first withdrawal).

An annuity contract with a GMWB feature is established with funds allocated to various investment options. Through an electronic interface, a systematic annuity valuation application is used to create a rising stream of income. The annuity valuation application can be embodied in a computer readable medium bearing instructions that, when executed, cause a computer to perform the annuity valuation method.

The person or persons for whom withdrawals are guaranteed under the GMWB feature can be referred to as the “Covered Person(s).” In various embodiments, the GMWB feature can cover different periods of time. In some embodiments, the GMWB feature can cover a predetermined period of time. In yet other embodiments, the GMWB feature can cover a period of time based upon the life of at least one Covered Person. For example, the GMWB feature may cover the life of the contract owner, the lives of both the contract owner and his/her spousal beneficiary, or the lives of a plurality of Covered Persons. In still other embodiments, the GMWB feature can cover the longer of a predetermined period of time or the life of the contract owner, the lives of both the contract owner and his/her spousal beneficiary, or the lives of a plurality of Covered Persons.

The annuity contract with GMWB feature can be owned by an individual or spousal joint owners. If a contract is owned by non-spousal joint owners and either owner dies, the full contract value can be required to be paid within a predetermined time (e.g., five years) of death, after which time the contract terminates; the surviving owner may not receive the benefit of the GMWB feature.

The GMWB feature can be adapted to help create a guaranteed income stream that will last as long as the Covered Person lives, or as long as the Covered Person and his/her spouse live or as long as the last of a plurality of Covered Persons live if that feature is selected, even if the entire value of the contract has been reduced to zero, provided withdrawals taken are within the parameters of the feature. The GMWB feature can offer protection in the event the contract value declines due to unfavorable investment performance, certain withdrawal activity, if the Covered Person(s) live longer than expected, or any combination of these factors. The value of the annuity account can be dependent upon the performance of the investment(s) associated with the annuity account, the withdrawal activity of the Covered Person(s), and the lifespan of the Covered Person(s).

The GMWB feature can offer the opportunity to “lock-in” at the end of a predetermined period, such as a one-year period, for example, the greater of (1) actual investment gains on the contract period anniversary or (2) an income credit determined as a percentage (Income Credit Percentage), such as a percentage up to about 7%, for example, of an Income Credit Base. The lock-in function can be available during a predetermined number of periods, such as during the first five years of the contract extendible in five-year increments up to fifteen years, for example. This locked-in amount, which is the basis of the Covered Person(s) guaranteed lifetime benefit, can be referred to as the Income Base.

The contract owner may wait to take withdrawals or take withdrawals immediately. If withdrawals are taken, the contract owner may withdraw an amount less than or equal to a Maximum Periodic Withdrawal Amount in each Benefit Period without reducing the Income Base or the Income Credit Base. The Maximum Periodic Withdrawal Amount can be based upon the Income Base. For example, the Maximum Periodic Withdrawal Amount can be determined by multiplying the Income Base by a withdrawal percentage. If the contract owner takes withdrawals in a Benefit Period that are less than or equal to the Maximum Periodic Withdrawal Amount, the Income Credit Percentage can be reduced on the Benefit Period anniversary based on the withdrawal amount. For example, in one embodiment, the Income Credit Percentage can be reduced by a percentage calculated as the sum of all withdrawals taken during the preceding Benefit Period, divided by the Income Base, prior to determining the Income Base for the next Benefit Period.

The withdrawal percentage can be determined in some embodiments by the age of the contract owner, if the single life option is elected, or the age of the younger spouse, if the joint life option is elected, at the time of the first withdrawal. In some embodiments, the withdrawal percentage can increase as the age of the contract owner/younger spouse increases.

For example, a schedule of withdrawal percentages can be determined in which a first fixed withdrawal percentage is assigned a first age range and a second fixed withdrawal percentage is assigned a second age range. In an illustrative embodiment, for a first age range including ages 45-61, the withdrawal percentage is 4%, and for a second, older age range including ages 62 and over, the withdrawal percentage is 5%.

Each withdrawal decreases the contract value of the annuity account. In some embodiments, if the contract owner takes a withdrawal in a given Benefit Period that exceeds the Maximum Periodic Withdrawal Amount (“Excess Withdrawal”), the Income Credit Base and the Income Base are reduced and the Income Credit is not available on the following contract period anniversary.

The Annuity Contract with the GMWB Feature

The GMWB feature can be a part of an annuity contract or can be in the form of a rider that attaches to an existing annuity contract. An exemplary embodiment of a rider suitable for use with the GMWB feature is found in an Appendix to the instant disclosure.

### Covered Person(s)

The contract owner can elect to have the GMWB feature cover only his/her life or the lives of both the contract owner and his/her spouse. The person or persons whose lifetime withdrawals are guaranteed under the GMWB feature can be referred to as the “Covered Person(s).” If the contract is not owned by a natural person, references to owner(s) can apply to the annuitant(s). The GMWB feature can be configured such that, to be eligible to elect this feature, the Covered Persons must meet a predetermined age requirement. The age requirement can vary depending on the type of contract purchased and the number of Covered Persons. For example, a minimum age for eligibility can be 45 and a maximum age can be 80.

### Effective Date

The GMWB feature can be elected at the time of issuance of an original annuity contract for immediate effectiveness or subsequently secured. If the GMWB feature is part of an original annuity contract, the GMWB feature can be effective on an Effective Date established by the annuity contract. If the GMWB feature is elected after initial purchasing of the annuity contract, the GMWB feature can be effective on the first contract period anniversary after the election (the “Effective Date”).

### Eligible Purchase Payments

The GMWB feature can be configured to guarantee that only certain Eligible Purchase Payments are included in the Income Base. Eligible Purchase Payments can be considered those payments received during the contract's first five years, for example, or some proportion of payments made during a predetermined time that depends upon the amount of the first Eligible Purchase Payment.

The Eligible Purchase Payments can include the first purchase payment made to issue the annuity contract or to activate the GMWB feature on an existing annuity. In some embodiments, the Eligible Purchase Payments can also include some or all of additional purchase payments made in the first period. In some embodiments, the Eligible Purchase Payments can also include some or all of additional purchase payments made in a predetermined set of subsequent periods.

In one embodiment, Eligible Purchase Payments include 100% of Purchase Payments received during the first contract period and Purchase Payments received in each of contract periods 2-5, capped in each period at an amount equal to 100% of the Purchase Payments received in period 1. For example, if a contract owner made a $100,000 Purchase Payment in year 1 (where the period is equal to one year), Eligible Purchase Payments will include additional Purchase Payments of up to $100,000 contributed in each of contract years 2-5 for a grand total maximum of $500,000 of Eligible Purchase Payments. Any Purchase Payments made in contract periods 2-5 in excess of the annual cap amount as well as all Purchase Payments received after the 5th contract period are considered Ineligible Purchase Payments.

The GMWB feature can be configured such that the calculation of Eligible Purchase Payments does not include any spousal continuation contributions; however, continuation contributions can be included in the calculation of Anniversary Values. Total Eligible Purchase Payments can be limited to a predetermined maximum total, such as $1,500,000, without the administering entity's prior approval.

### Lock-In Function

Income Base Evaluation Phase and Income Credit Phase

The Income Base Evaluation Phase is the period of time over which Anniversary Values and, if applicable and greater, the Income Base plus any available Income Credit are considered to determine the increase, if any, to the Income Base. The Income Credit Phase is the period of time over which the Income Credit is calculated. The initial Income Credit Phase and the initial Income Base Evaluation Phase begin on the Effective Date and end a predetermined period of time later, such as five years later where the period is equal to one year.

The GMWB feature can lock-in the greater of two values in determining the Income Base. The Income Base determines the basis of the Covered Person(s)' guaranteed lifetime benefit which may be taken in a series of withdrawals. Each consecutive period starting from the Effective Date can be considered a Benefit Period. A new Income Base can be automatically locked-in each period on each Benefit Period anniversary during the Income Base Evaluation Phase and the Income Credit Phase based on the greater of either (1) the highest Anniversary Value or (2) the Income Base increased by any available Income Credit. In some embodiments, the Income Base Evaluation Phase and the Income Credit Phase can be the same time period, such as the first five years following the Effective Date where the period is equal to one-year. In other embodiments, the Income Base Evaluation Phase can be a different amount of time than the Income Credit Evaluation Phase.

Anniversary Value

The GMWB feature can be configured to periodically calculate an Anniversary Value which equals the contract value on any contract period anniversary during the Income Base Evaluation Phase minus any Ineligible Purchase Payments.

Income Base

The GMWB feature can be configured to periodically determine the Income Base which can be initially equal to the First Eligible Purchase Payment. If the GMWB feature is elected after contract issue, the initial Income Base can be the contract value on the Effective Date. In each subsequent Benefit Period, the Income Base can be equal to the Income Base at the beginning of the Benefit Period plus any subsequent Eligible Purchase Payments made during that Benefit Period, less proportionate adjustments for Excess Withdrawals that occurred during that Benefit Period. On each Benefit Period anniversary, the administering entity can determine if the Income Base should be increased based on the maximum Anniversary Value or any available Income Credit.

Income Credit Base

The GMWB feature can be configured to determine the Income Credit Base which can be used as a basis for calculating the Income Credit during an Income Credit Phase. The initial Income Credit Base can be equal to the first Eligible Purchase Payment. If the GMWB feature is elected after contract issue, the initial Income Credit Base can be equal to the contract value on the Effective Date.

Income Credit

The GMWB feature can be configured to determine the Income Credit which is an amount equal to a fixed percentage (“Income Credit Percentage”), such as 7%, for example, of the Income Credit Base, on each Benefit Period anniversary. If the contract owner takes withdrawals in a Benefit Period that are less than or equal to the Maximum Periodic Withdrawal Amount, the Income Credit Percentage on the Benefit Period anniversary can be reduced by a percentage calculated as the sum of all withdrawals taken during the preceding Benefit Period, divided by the Income Base, prior to the determining the Income Base for the next Benefit Period. The GMWB feature can be configured such that, if the contract owner takes a withdrawal that is greater than the Maximum Periodic Withdrawal Amount in the preceding Benefit Period, the Income Credit is equal to zero.

Increasing the Income Base and Income Credit Base

On each Benefit Period anniversary during an Income Base Evaluation Phase, the administering entity can determine if the Income Base should be increased based on the maximum Anniversary Value or any available Income Credit. The Maximum Anniversary Value equals the highest Anniversary Value on any Benefit Period anniversary occurring during the Income Base Evaluation Phase. On each Benefit Period anniversary during the Income Base Evaluation Phase, the Income Base is automatically increased to the Anniversary Value when the Anniversary Value is greater than (a), (b), and (c), where:
(a) is the cumulative Eligible Purchase Payments; and
(b) is the current Income Base, increased by the Income Credit, if any; and
(c) is all previous Anniversary Values during any Income Base Evaluation Period.
   The Income Base will not increase even if the contract value on days other than the Benefit Period anniversary was greater than the Income Base on the Benefit Period anniversary.

On each Benefit Period anniversary during the Income Credit Phase, the amount to which the Income Credit Base and/or the Income Base could increase is determined. The components used to determine this amount are:
(a) the Income Base calculated based on the maximum Anniversary Value; and
(b) the current Income Base plus the Income Credit.
   If (a) is greater than or equal to (b), the Income Credit Base and the Income Base are increased to the current Anniversary Value. If (b) is greater than (a), the Income Base is increased by the Income Credit and the Income Credit Base remains unchanged.

Extending the Income Base Evaluation Phase and the Income Credit Phase

In some embodiments, the Income Base Evaluation Phase and the Income Credit Phase over which the feature locks-in either the highest Anniversary Value or the Income Base plus any Income Credit can be extended, such as for two additional five year periods (“First Extension” and “Second Extension,” respectively), for example, for a fee provided that the oldest Covered Person is younger than a prescribed age, such as age 85 or younger, for example, at the time of each extension. The GMWB feature can be configured such that after election of the First Extension and the Second Extension, only the Income Base Evaluation Phase over which the feature locks-in the highest Anniversary Value (“Subsequent Extension(s)”) is extendible provided that the oldest Covered Person is age 85 or younger at the time of each Subsequent Extension. As a result, in such embodiments, the Income Credit is not available for Subsequent Extensions.

In one embodiment, the Income Base Evaluation Phase and the Income Credit Phase can both be extended at the First Extension. Eligibility for the Second Extension can depend upon whether the First Extension was elected.

Prior to the end of the initial Income Base Evaluation Phase and the initial Income Credit Phase and prior to the end of each evaluation phase, the administering entity can inform the contract owner of the terms of the next extension in writing. If the contract owner elects extension(s), the contract owner may be required to contact the administering entity in writing before the end of each evaluation phase to notify the administering entity of the election to extend the phase. The components of the GMWB feature can be required to change to those in effect at the time of extension, such as the fee, Maximum Periodic Withdrawal Percentage, and investment requirements, which may be different from the components when the contract owner initially elected the GMWB feature.

### Maximum Periodic Withdrawal Percentage (MPW %)

The Maximum Periodic Withdrawal Percentage (MPW %) represents the percentage of the Income Base used to calculate the Maximum Periodic Withdrawal Amount (MPWA) that may be withdrawn each period. The GMWB feature can be configured such that the Maximum Periodic Withdrawal Percentage is determined by the age of the Covered Person(s) at the time of the first withdrawal. The tables below show illustrative schedules of MPW %'s based on the age of the Covered Person(s) at the time of the first withdrawal.

One Covered Person

If the GMWB feature is elected to cover one life but the contract is jointly owned, then the GMWB feature can be configured such that the Covered Person must be the older owner and the following is applicable:

| Age of the Covered Person at Time | Maximum Periodic |
|---|---|
| of First Withdrawal | Withdrawal Percentage |
| Prior to 62nd Birthday | 4% of Income Base |
| On or after 62nd Birthday | 5% of Income Base |

Two Covered Persons

If the feature is elected to cover two lives, the GMWB feature can be configured such that the following is applicable:

| Age of the Younger Covered Person or | |
|---|---|
| Surviving Covered Person at Time of | Maximum Periodic |
| First Withdrawal | Withdrawal Percentage |
| Prior to 62nd Birthday | 4% of Income Base |
| On or after 62nd Birthday | 5% of Income Base |

### Maximum Periodic Withdrawal Amount

The GMWB feature can be configured such that the Maximum Periodic Withdrawal Amount represents the maximum amount that may be withdrawn each Benefit Period following the Effective Date without reducing the Income Base, and if applicable, the Income Credit Base. The GMWB feature can be configured such that the Maximum Periodic Withdrawal Amount is calculated by multiplying the Income Base by the applicable Maximum Periodic Withdrawal Percentage, such as those shown in the tables above.

### Impact on the Maximum Periodic Withdrawal Amount Based Upon Increases and Decreases in the Income Base

Increases in the Income Base

In any Benefit Period where Eligible Purchase Payments are allocated to the contract, any remaining withdrawals of the Maximum Periodic Withdrawal Amount can be based on the increased Maximum Periodic Withdrawal Amount reduced by withdrawals previously taken in that Benefit Period. If the Income Base is increased on a Benefit Period anniversary, the Maximum Periodic Withdrawal Amount can be recalculated on that Benefit Period anniversary by multiplying the increased Income Base by the applicable Maximum Periodic Withdrawal Percentage.

Decreases in the Income Base

Excess Withdrawals reduce the Income Base on the date the Excess Withdrawal occurs. Any Excess Withdrawal in a Benefit Period can reduce the Income Base in the same proportion by which the contract value is reduced by the Excess Withdrawal. As a result of a reduction of the Income Base, the new Maximum Periodic Withdrawal Amount will be equal to the reduced Income Base multiplied by the applicable Maximum Periodic Withdrawal Percentage. The last recalculated Maximum Periodic Withdrawal Amount in a given Benefit Period is available for withdrawal at the beginning of the next Benefit Period and may be lower than the previously calculated Maximum Periodic Withdrawal Amount. When the contract value is less than the Income Base, Excess Withdrawals will reduce the Income Base by an amount which is greater than the amount of the Excess Withdrawal. In addition, the GMWB feature can be configured such that no Income Credit will be added to the Income Base in that Benefit Period.

### Minimum Income Base

The GMWB feature can be configured such that, if the contract owner does not take any withdrawals before a predetermined time period, such as the tenth Benefit Period anniversary where the period is equal to one year, the Income Base can be guaranteed to equal a certain minimum amount (“Minimum Income Base”). For example, on the tenth Benefit Period anniversary following the Effective Date, the Income Base, and if applicable, the Income Credit Base, will be increased to equal a predetermined amount, such as at least 200% of the first Benefit Year's Eligible Purchase Payments, if the contract owner elected the GMWB feature at contract issue. If the contract owner elected the GMWB feature after contract issue, the Minimum Income Base is equal to 200% of the contract value as of the Effective Date. The contract owner need not elect extensions in order to be eligible to receive the Minimum Income Base.

The GMWB feature can be configured such that, if the contract owner is eligible for the Minimum Income Base, the Income Base is equal to the greatest of (a), (b) and (c), where:
(a) is the current Income Base, or if the First Extension was elected, the Income Base calculated based on the maximum Anniversary Value; and
(b) is the current Income Base plus the Income Credit, if applicable; and
(c) is the Minimum Income Base.

### Withdrawals

All withdrawals, including withdrawals taken under the GMWB feature, reduce the contract value of the annuity account and the death benefit of the underlying annuity contract. In addition, in some embodiments, withdrawals under the GMWB feature can reduce the free withdrawal amount and may be subject to applicable withdrawal charges if in excess of the Maximum Periodic Withdrawal Amount. In some embodiments, the sum of withdrawals in any contract period up to the MPWA are not assessed a withdrawal charge.

The Maximum Periodic Withdrawal Amount, the Income Base and Income Credit Base may change over time as a result of the timing and amount of withdrawals. The GMWB feature can be configured such that, if the contract owner takes a withdrawal before a predetermined time, such as the tenth Benefit Period Anniversary, the Income Base, and if applicable, the Income Credit Base, are not eligible to be increased to the Minimum Income Base.

The GMWB feature can be configured such that withdrawals made during a contract period that in total are less than or equal to the Maximum Periodic Withdrawal Amount will not reduce the Income Base or Income Credit Base. The GMWB feature can be configured such that, if the contract owner chooses to take less than the Maximum Periodic Withdrawal Amount in any contract period, the contract owner may not carry over the unused amount into subsequent periods. The Maximum Periodic Withdrawal Amount may not be recalculated solely as a result of taking less than the entire Maximum Periodic Withdrawal Amount in any given period.

The GMWB feature can be configured such that withdrawals in excess of the Maximum Periodic Withdrawal Amount are considered Excess Withdrawals. Excess Withdrawals are any portion of a withdrawal that causes the total withdrawals in a Benefit Period to exceed the Maximum Periodic Withdrawal Amount, including but not limited to any withdrawal in a contract period taken after the Maximum Periodic Withdrawal Amount has been withdrawn.

The GMWB feature can be configured such that, if the contract owner must take a required minimum distributions (“RMD”) from the annuity account, and the amount of the RMD (based only on the annuity contract in question) is greater than the Maximum Periodic Withdrawal Amount in any given Benefit Period, no portion of the RMD will be treated as an Excess Withdrawal. Any portion of a withdrawal in a Benefit Period that is more than the greater of both the Maximum Periodic Withdrawal Amount and the RMD amount (based only on the annuity contract in question) will be considered an Excess Withdrawal. A contract owner can establish an automated monthly minimum distribution withdrawal program administered by an annuity service center of the insurance company.

Income Base and Income Credit Base.

The GMWB feature can be configured such that, if the sum of withdrawals in any Benefit Period exceeds the Maximum Periodic Withdrawal Amount, the Income Base and Income Credit Base will be reduced for those withdrawals. For each Excess Withdrawal taken, the Income Base and Income Credit Base can be reduced in the same proportion by which the contract value is reduced by each Excess Withdrawal.

Maximum Periodic Withdrawal Amount.

The GMWB feature can be configured such that the Maximum Periodic Withdrawal Amount is recalculated each time there is a change in the Income Base. Accordingly, if the sum of withdrawals in any contract period does not exceed the Maximum Periodic Withdrawal Amount for that period, the Maximum Periodic Withdrawal Amount will not change for the next period unless the Income Base is increased. If the contract owner takes an Excess Withdrawal, the Maximum Periodic Withdrawal Amount can be recalculated by multiplying the reduced Income Base by the existing Maximum Periodic Withdrawal Percentage. This recalculated Maximum Periodic Withdrawal Amount is available for withdrawal at the beginning of the next Benefit Period and may be lower than the previous Maximum Periodic Withdrawal Amount.

Contract Value is Equal to Zero

All withdrawals from the contract, including withdrawals under the GMWB feature, will reduce the contract value. Unfavorable investment experience may also reduce the contract value. The GMWB feature can be configured such that, if the contract value is reduced to zero but the Income Base is greater than zero, the administering entity will continue to pay guaranteed payments under the terms of the GMWB feature over the lifetime of the Covered Person(s). Any amounts that the administering entity may pay under the GMWB feature in excess of the contract value can be made subject to the administering entity's financial strength and claims-paying ability. The GMWB feature can be configured such that, if at any time an Excess Withdrawal(s) should reduce the contract value to zero, no further benefits will remain under the GMWB feature and the contract along with the GMWB feature will terminate.

If the contract value is reduced to zero, the contract's other benefits can be terminated. The contract owner may no longer make subsequent Purchase Payments or transfers, and no death benefit or future annuity income payments are available.

In some embodiments, when the contract value equals zero but a benefit remains payable, to receive any remaining benefit, the contract owner may be required to select one of the following options for payment:
1. The current Maximum Periodic Withdrawal Amount, divided equally and paid on a quarterly, semi-annual or annual frequency as selected by the contract owner until the date of death of the Covered Person(s); or
2. Any payment option mutually agreeable between the contract owner and the administering entity.
   If the contract owner does not select a payment option above, the administering entity can determine to pay the contract owner the remaining benefit as the current Maximum Periodic Withdrawal Amount divided equally and paid on a quarterly basis until the date of death of the Covered Person(s).

### Investment Allocations

The annuity contract can be configured to require the contract owner to allocate the investment in at least one of a plurality of options. For example, the annuity contract can require that the contract owner allocate the investment funds into a portfolio allocator model or a blend of “balanced” portfolios, for example. An example of variable annuity using a portfolio allocator model are those commercially-available from AIG SunAmerica Life Assurance Company of Woodland Hills, Calif., marketed under the family trade name Polaris variable annuities. The annuity contract can require that the investment is automatically re-balanced on a periodic basis, such as automatic quarterly asset rebalancing, for example.

Allocation instructions accompanying any Purchase Payment can be required to comply with the investment requirements, described above, in order for the application or subsequent Purchase Payment(s) to be considered in good order. The investment can be automatically enrolled in an Automatic Asset Rebalancing Program with quarterly rebalancing. Quarterly rebalancing can be helpful to identify market performance and transfer and withdrawal activity that may result in the contract's allocations going outside the predetermined investment restrictions. Quarterly rebalancing can help ensure that allocations continue to comply with the investment requirements for the GMWB feature. In addition to quarterly rebalancing, the contract owner can initiate rebalancing after any of the following transactions any non-systematic transfer or withdrawal.

The contract owner can provide the administering entity with automatic asset rebalancing instructions that can be kept on file in the data storage device. If at any point, for any reason, the Automatic Asset Rebalancing Program instructions would result in allocations inconsistent with the investment requirements of the GMWB feature, the administering entity can revert to the last compliant instructions on file whether for rebalancing or for allocation of a Purchase Payment. The contract owner can modify the Automatic Asset Rebalancing Program instructions, as long as they are consistent with the investment requirements of the GMWB feature, at any time by contacting an Annuity Service Center by telephone or by e-mail, for example.

The administering entity can reserve the right to change the investment requirements at any time for prospectively issued contracts. The administering entity can revise the investment requirements for any existing contract to the extent that investment portfolios are added, deleted, substituted, merged or otherwise reorganized. The administering entity can notify the contract owner of any changes to the investment requirements due to deletions, substitutions, mergers or reorganizations by a predetermined amount of time in advance of the change, such as 30 days in advance, for example.

### Administrative Fee

The GMWB feature can be configured such that the fee for the GMWB feature can depend on the number of covered lives. For example, the annualized fee can be 0.95% of the Income Base for one Covered Person and 1.20% of the Income Base for Two Covered Persons. An increase in the Income Base due to an adjustment to a higher Anniversary Value, addition of an Income Credit, or subsequent Eligible Purchase Payments will result in an increase to the dollar amount of the administrative fee.

The fee can be calculated and deducted periodically, such as quarterly, from the contract value, starting on the first quarter following the Effective Date and ending upon termination of the feature. Once the contract owner elects the GMWB feature, the contract owner can be assessed a non-refundable fee regardless of whether or not the contract owner takes any withdrawals and/or receives any lifetime annuity income payments under this feature. The GMWB feature can be configured such that new fees and conditions apply upon the extension of the Income Base Evaluation Phase and the Income Credit Phase.

The GMWB feature can be configured such that, if the contract value falls to zero before the GMWB feature has been terminated, the fee will no longer be deducted. In some embodiments, the administering entity does not assess the periodic fee if the contract owner annuitizes the contract or if a death benefit is paid before the end of a contract period. If the GMWB feature is still in effect and the contract owner surrenders the contract, the administering entity may assess a pro-rata charge for the fee if the contract owner surrenders the contract before the end of a contract period. The pro-rata charge can be calculated by multiplying the full periodic fee by the number of days between the date the fee was last assessed and the date of surrender divided by the number of days in that contract period.

### Death of Covered Person(s)

The GMWB feature can be configured such that, if there is one Covered Person and that person dies, the surviving spousal joint owner or spousal beneficiary may elect to:
1. make a death claim if the contract value is greater than zero which terminates the GMWB feature and the annuity contract; or
2. continue the contract if the contract value is greater than zero, without the GMWB feature and its corresponding fee.

The GMWB feature can be configured such that, if there are multiple Covered Persons, upon the death of one Covered Person, the surviving Covered Person(s) may elect to:
1. make a death claim if the contract value is greater than zero, which terminates the GMWB feature and the annuity contract; or
2. continue the contract with the GMWB feature and its corresponding fee.

The components of the GMWB feature in effect at the time of spousal continuation can be left unchanged. In some embodiments, the surviving Covered Person can elect to receive withdrawals in accordance with the provisions of the GMWB feature based on the age of the younger Covered Person when the first withdrawal was taken. If no withdrawals were taken prior to the spousal continuation, the Maximum Periodic Withdrawal Percentage can be based on the age of the surviving Covered Person at the time the first withdrawal is taken.

If spousal continuation occurs during the Income Base Evaluation Phase and/or the Income Credit Phase, if applicable, the Continuing Spouse can continue to receive any increases to the Income Base during the remaining Income Base Evaluation Phase and/or the Income Credit Phase. The Continuing Spouse can be eligible to receive the Minimum Income Base if no withdrawals have been taken during a predetermined amount of time, such as the first ten Benefit Periods following the Effective Date. In addition, the Continuing Spouse can be eligible to elect to extend the Income Base Evaluation Phase and the Income Credit Phase upon the expiration of the phase.

In some embodiments, upon the death of the Covered Person(s), if the contract value is greater than zero, a non-spousal beneficiary may be required to make an election under the death benefit provisions of the annuity contract, which terminates the GMWB feature.

### Latest Annuity Date

If the contract value and the Income Base are greater than zero on the Latest Annuity Date, the contract owner may be required to select one of the following options:
1. annuitize the contract value under the contract's annuity provisions; or
2. elect to receive the current Maximum Periodic Withdrawal Amount on the Latest Annuity Date, divided equally and paid on a quarterly, semi-annual or annual frequency as selected by the contract owner until the date of death of the Covered Person(s); or
3. any payment option mutually agreeable between the contract owner and the administering entity.
   If the contract owner does not elect an option listed above, on the Latest Annuity Date, the administering entity may annuitize the contract value. At that point, the accumulation phase of the annuity contract ends and the income phase begins.

### Cancelling the GMWB Feature

The GMWB feature can be configured such that it can be cancelled. For example, in some embodiments, the GMWB feature can be cancelled on the fifth Benefit Period anniversary, the tenth Benefit Period anniversary, or any Benefit Period anniversary after the tenth Benefit Period anniversary. Once the GMWB feature is cancelled, the contract owner will no longer be charged a fee and the guarantees under the GMWB feature are terminated. In addition, the investment requirements for the GMWB feature may no longer apply to the annuity contract. After cancellation, the contract owner may be prohibited from extending the Income Base Evaluation Phase or Income Credit Phase and from re-electing or reinstating the GMWB feature.

### Automatic Termination of the GMWB Feature

The GMWB feature can be configured to automatically terminate upon the occurrence of a predetermined event. For example, the GMWB feature can be automatically terminated upon the occurrence of any one of the following:
1. annuitization of the contract; or
2. termination or surrender of the contract; or
3. a death benefit is paid and the contract is terminated; or
4. Excess Withdrawals reduce the contract value to zero; or
5. death of the Covered Person, if only one is elected; or, if two are elected, death of the surviving Covered Person; or
6. a change that removes all Covered Persons from the contract.

If a change of ownership occurs from a natural person to a non-natural entity, the original natural owner(s) can be required to also be the annuitant(s) after the ownership change to prevent termination of the GMWB feature. A change of ownership from a non-natural entity to a natural person can only occur if the new natural owner(s) was the original natural annuitant(s) in order to prevent termination of the GMWB feature. Any ownership change can be made contingent upon prior review and approval by the administering entity.

### Termination of Coverage for One of Two Covered Persons

The GMWB feature can be configured to provide a guarantee for one Covered Person and not the lifetime of the other Covered Person. For example, in some embodiments, the guarantee can be removed for the lifetime of one of the Covered Persons where:
1. one of the two Covered Persons is removed from the contract, due to reasons other than death; or
2. the original spousal joint Owners or spousal beneficiary, who are the Covered Persons, are no longer married at the time of death of the first spouse.
   Under these circumstances, the fee for the GMWB feature based on two Covered Persons can remain unchanged and the guaranteed withdrawals are payable for one Covered Person only. However, the remaining Covered Person may choose to terminate the GMWB feature.

### Computing Environment

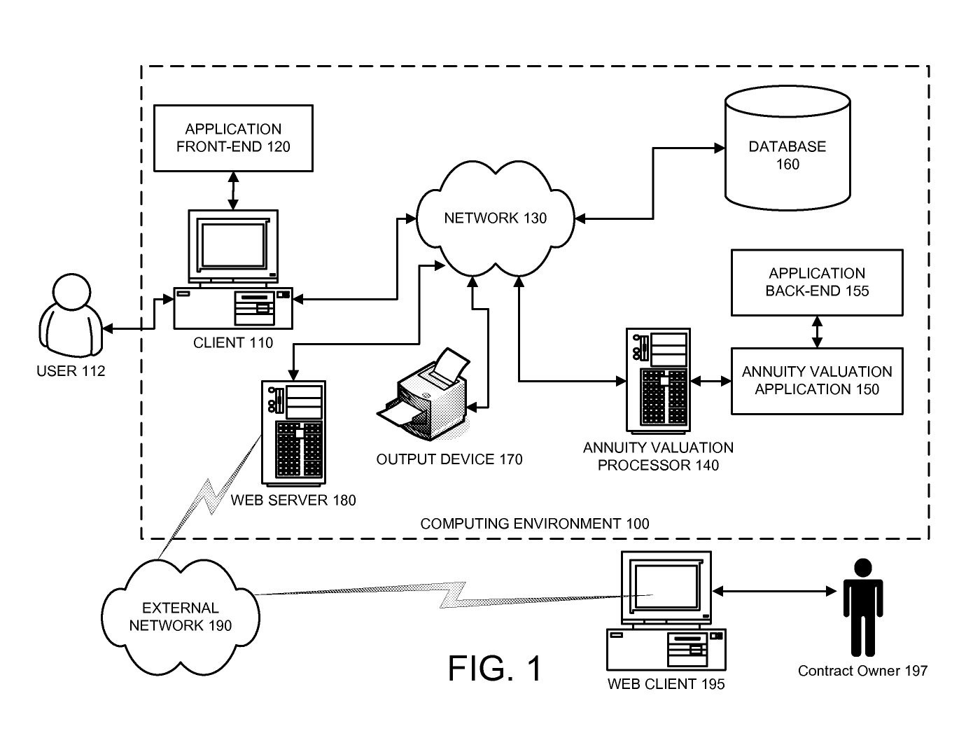

FIG. 1 illustrates an embodiment of a computing environment 100. The computing environment 100 can include a number of computer systems, which generally can include any type of computer system based on: a microprocessor, a mainframe computer, a digital signal processor, a portable computing device, a personal organizer, a device controller, or a computational engine within an appliance. More specifically, the computing environment 100 can include a client 110, an application front-end 120, an internal network 130, at least one annuity valuation processor 140, an annuity valuation application 150, an application back-end 155, a database 160, at least one output device 170, and a web server 180 operatively connected to an external network 190. The input device 110, the annuity valuation processor 140, the databases 160, the output device 170, and the web server 180 are operatively connected together via the internal network 130.

The client 110 can be used to communicate with a user, to enter annuity account data into the database 160, and/or to execute the annuity valuation application 150. The client 110 can comprise at least one input device. The client 110 can generally include any node on a network including computational capability and including a mechanism for communicating across the network. In one embodiment, the client 110 hosts the application front end 120.

The application front end 120 can generally include any component of an application, such as the annuity valuation application 150, that can receive input from the user 112 or the client 110, communicate the input to the annuity valuation application 150, receive output from the annuity valuation application 150, and present the output to the user 112 or the client 110. In one embodiment, the application front end 120 can be a stand-alone system.

The network 130 can generally include any type of wired or wireless communication channel capable of coupling together computing nodes. This includes, but is not limited to, a local area network, a wide area network, or a combination of networks.

The annuity valuation processor 140 can generally include any computational node including a mechanism for servicing requests from a client for computational resources, data storage resources, or a combination of computational and data storage resources. Furthermore, the annuity valuation processor 140 can generally include any system that can host the annuity valuation and administration application 150. In one embodiment, the annuity valuation processor 140 hosts the annuity valuation application 150. A report engine can be provided to generate displays of information stored in the database 160 concerning an annuity account with the GMWB feature, which can be viewed using the output device 170, for example. In one embodiment, report engine 150 further provides pre-configured and/or ad hoc reports relating to one or more annuity contracts.

In some embodiments, the annuity valuation application 150 can include the application front end 120 and the application backend 155. In one embodiment, the annuity valuation application 150, the application front end 120, and the application back end 155 are independent of each other. In this embodiment, the annuity valuation application 150, the application front end 120, and the application back end 155 can each communicate with each other via the network 130, or through any other system for facilitating communication between independent systems.

The application back end 155 can generally include any component of an application, such as the annuity valuation application 150, that can process data, interact with the database 160, and execute business logic for the application. In one embodiment, the annuity valuation processor 140 hosts the application back end 155. In one embodiment, the application back end 155 can be a stand-alone system.

The database or data storage device 160 can generally include any type of system for storing data in non-volatile storage. This includes, but is not limited to, systems based upon: magnetic, optical, and magneto-optical storage devices, as well as storage devices based on flash memory and/or battery-backed up memory. In one embodiment, the database 160 can store information associated with an annuity account.

The output device 170 can comprise a printer, a display monitor, and a connection to another device, for example. The output device 170 can be used to generate reports for sending to the contract owner which contain information generated by the annuity valuation application 150. The output device 170 can be used to communicate to the user 112 information about the annuity account generated by the annuity valuation application 150.

The user 112 can generally include: an individual, a group of individuals, an organization, a group of organizations, a computing system, a group of computing systems, or any other entity that can interact with the computing environment 100. In one embodiment, the user 112 can be a client.

The web server 180 can be provided to facilitate the communication of a contract owner (or his agent) with the computing environment 100 via the external network 190. The web server 180 can provide a suitable web site or other Internet-based graphical user interface which is accessible by a contract owner 197, for example. A web client 195 can be connected to the web server 180 through a network connection (e.g., Internet, Intranet, LAN, WAN and the like). The web server 180 can use an authentication server in order to validate and assign proper permissions to authorized users of the system. A permission database can store user credentials and permissions specific to each user. The web server 180 can be outfitted with a firewall such that requests originating from outside the computing environment pass through the firewall before being received and processed at the web server 180.

In addition to the components discussed above, the computing environment can further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

In one embodiment, the computing environment can include at least one processor for execution of a valuation application for an annuity account of an annuitant. The annuity account has funds allocated to at least one investment. The annuity account includes an accumulation phase with a guarantee for an increased benefit base over a predetermined period of time and a guaranteed minimum withdrawal stream for a period of time or for the life of the annuitant.

A database can be associated with the processor. The database contains information about the annuity account including an initial Benefit Base (BB), a Credit Benefit Base (CBB), a Maximum Periodic Withdrawal Amount (MPWA), a Crediting Rate (CR), and a Maximum Periodic Withdrawal Percentage (MPW %).

The annuity information contained in the database can include the total number of time periods (Nₜₒₜₐₗ) in the term of the annuity, the number of time periods (N_{lock}) for which increases in the contract value of the annuity contract investment (CV) can be locked in to the BB, and the number of time periods (N_{IC}) for which the Income Credit is determined. The value for N_{lock} can be less than the value for Nₜₒₜₐₗ. The value for N_{IC} can be less than the value for Nₜₒₜₐₗ. In some embodiments, the value for N_{lock} can be the same as the value for N_{IC}.

The valuation application executed by the at least one processor periodically determines a Current Value of the annuity contract investment (CV). For each withdrawal, the annuity valuation application determines if the current MPWA is exceeded and reduces the current BB and the CBB by the amount the withdrawal exceeds the current MPWA (Excess Withdrawal). The annuity valuation application periodically determines updated values for an Income Credit (IC), BB, CBB, and MPWA.

If no withdrawal is taken in the prior period, then:
The annuity valuation application can set IC equal to CBB×CR.
If CV is greater than IC+BB, the annuity valuation application updates the value of BB and CBB for the next period to equal CV.
If CV is not greater than IC+BB, the annuity valuation application updates the value of BB for the next period to equal the existing value of BB+IC.
The annuity valuation application sets the value of MPWA for the next period to equal MPW %×the BB for the next period,

If a withdrawal is taken in the prior period and the withdrawal(s) in the prior period do not exceed the MPWA, then:
The annuity valuation application determines a Withdrawal Rate (WR) which is equal to the sum of all withdrawals in the prior period divided BB.
The annuity valuation application sets IC=CBB×(CR−WR).
If CV is greater than IC+BB, the annuity valuation application updates the value of BB and CBB for the next period to equal CV.
If CV is not greater than IC+BB, the annuity valuation application updates the value of BB for the next period to equal the existing value of BB+IC.
The annuity valuation application sets the value of MPWA for the next period equal to MPW %×the BB for the next period.

If a withdrawal is taken in the prior period and the withdrawal(s) in the prior period exceed the MPWA, then:
The annuity valuation application sets IC=0.
The annuity valuation application sets BB and CBB equal to the values they were adjusted downward for the Excess Withdrawal(s) with BB offset upwardly to the extent that CV exceeds BB prior to any adjustments for withdrawals in the prior period.

The valuation application can cease to update the value of the Benefit Base based upon the value of the Income Credit for periods after N_{IC} periods. The valuation application can cease to update the value of the Benefit Base based upon the Current Value of the annuity contract investment for periods after N_{lock} periods.

The system can include at least one input device operatively connected to the at least one processor. The system can include at least one output device operatively connected to the at least one processor. The system can include an internal network operatively connected to the at least one processor. The system can include an external network operatively connected to the at least one processor.

In some embodiments, an administration application can be provided to generate systematic payments which, over the course of the defined period, equal the MPWA and send the payments to the contract owner (or his/her designee) over the course of the period. The administration application can be executed by the annuity processor. In other embodiments a stand-alone processor can be provided for executing the administration application. In some embodiments, where the benefit valuation period is yearly, the administration application provides monthly payments to the contract owner of substantially equal amounts. In other embodiments, the administration application provides bi-monthly payments to the contract owner of substantially equal amounts for any given benefit period.

In another embodiment, a system for administering an annuity contract includes at least one processor for execution of a valuation application for an annuity account of an annuitant. The annuity account has funds allocated to at least one investment. The annuity account includes a term including a plurality of periods of time, an Income Base, an Income Base Evaluation Phase, an Income Credit Phase, and a Maximum Periodic Withdrawal Amount in a period that may be withdrawn without affecting an Income Base. The term of the annuity account can be equal to the life of the annuitant. In situations where the annuitant includes at least two Covered Persons, the term can be equal to the life of the longest-living covered person. In some embodiments, the period of time can be equal to one calendar year.

A data storage device containing information about the annuity account is operably arranged with the processor such that the information about the annuity account in the storage device is accessible to the processor and is modifiable by the processor.

The valuation application executed by the at least one processor sets an initial value for the Income Base and an initial value for an Income Credit Base. The valuation application can set the initial value for the Income Base equal to the first Eligible Purchase Payment for an original annuity contract with the GMWB feature or the contract value of the annuity at the first period anniversary after the Effective Date. Similarly, the valuation application can set the initial value for the Income Credit Base equal to the first Eligible Purchase Payment for an original annuity contract with the GMWB feature or the contract value of the annuity at the first period anniversary after the Effective Date.

The valuation application adjusts the Income Base upward based upon any subsequent Eligible Purchase Payment. The valuation application can be configured to treat as an Eligible Purchase Payment: (1) a payment made during the first period of the annuity and (2) a payment made during any period of a range of periods starting with the second period up to the amount of Eligible Purchase Payment(s) made in the first period. The valuation application can be configured to treat, as an Ineligible Purchase Payment, a payment made during any period of the range of periods starting with the second period in excess of the amount of Eligible Purchase Payment(s) made in the first period. The valuation application can be configured to treat, as an ineligible payment, a payment made subsequent to the range of periods starting with the second period.

The valuation application adjusts the Income Base and the Income Credit Base downward based upon any withdrawal that exceeds the Maximum Periodic Withdrawal Amount in the period. The valuation application reduces the contract value of the annuity by the amount of each withdrawal.

The valuation application periodically determines the anniversary value of the annuity which can be equal to the contract value of the annuity at the end of the period minus any Ineligible Purchase Payments. During the Income Base Evaluation Phase, the valuation application periodically determines the Income Base based upon the Anniversary Value of the annuity and any available Income Credit. The Income Base Evaluation Phase can elapse after a predetermined number of periods that is less than the term of the annuity.

During the Income Credit Phase, the valuation application periodically determines an Income Credit based upon the Income Credit Base. The valuation application can determine the Income Credit during the Income Credit Phase by multiplying the Income Credit base by a predetermined percentage.

The Income Credit Phase can elapses after a predetermined number of periods that is less than the term of the annuity. The Income Credit Phase can be the same length of time as the Income Base Evaluation Phase. In some embodiments, the Income Credit Phase and the Income Base Evaluation Phase can be extended at least one time for an additional fee.

The valuation application can periodically determine the Income Base during the Income Base Evaluation Phase and the Income Credit Phase by setting the Income Base equal to the greater of (i) a Maximum Anniversary Value and (ii) the current Income Base plus the Income Credit. The Maximum Anniversary Value is equal to the highest Anniversary Value occurring during the Income Base Evaluation Phase. If the Maximum Anniversary Value is greater than the current Income Base plus the Income Credit, the valuation application can set the Income Credit Base equal to the Maximum Anniversary Value. If the current Income Base plus the Income Credit is greater than the Maximum Anniversary Value, the valuation application can leave the Income Credit Base unchanged.

The valuation application can set the Income Base equal to a predetermined Minimum Income Base if no withdrawals occur prior to a predetermined number of periods. For example, the valuation application can set the Income Base equal to a Minimum Income Base that is equal to 200% of the Eligible Purchase Payment(s) received in the first period.

The valuation application periodically determines the Maximum Periodic Withdrawal Amount in a period based upon the Income Base. The valuation application can periodically determine the Maximum Periodic Withdrawal Amount in a period by multiplying the Income Base by a Withdrawal Percentage. The Withdrawal Percentage can be selected from a schedule of withdrawal percentages that varies based upon the age of the annuitant at the time of the first withdrawal. In situations where the annuity account is associated with at least two covered persons, the Withdrawal Percentage can be based upon the age of the youngest Covered Person.

In other embodiments, a system for valuing and administering an annuity account with a GMWB feature as described above can be provided. The system can include at least one processor for executing an annuity valuation application operably arranged with a database containing information about the annuity account with the GMWB feature. The annuity valuation application can determine values using any of the relationships described above for at least one of the following: Eligible Purchase Payment(s), Ineligible Purchase Payment(s), Income Base, Anniversary Value, Maximum Anniversary Value, Income Credit Base, Income Credit Percentage, Maximum Periodic Withdrawal Amount, Maximum Periodic Withdrawal Percentage, and Administrative Fee.

In yet another embodiment, a system includes a valuation processor adapted to execute a valuation application for an annuity account of an annuitant. The annuity account has funds allocated to at least one investment. The annuity account has a term including a plurality of periods of time, an Account Value based upon the value of the funds allocated to at least one investment, an Income Base for determining a guaranteed benefit, a Maximum Periodic Withdrawal Amount in a period that may be withdrawn without affecting the Income Base, and a minimum periodic increase of the Income Base.

In this embodiment, a data storage device is provided that contains annuity account information. The data storage device is operably arranged with the valuation processor such that the annuity account information in the storage device is accessible to the valuation processor and is modifiable by the valuation processor.

In this embodiment, the valuation application executed by the valuation processor periodically determines the Account Value of the annuity; periodically determines the Income Base using (i) the Account Value, (ii) the Income Base with the minimum periodic increase of the Income Base applied, or (iii) a predetermined combination of the Account Value and the Income Base with the minimum periodic increase of the Income Base applied; and periodically determines the Maximum Periodic Withdrawal Amount in a period based upon the Income Base.

As will be appreciated by one of ordinary skill in the art, the invention may be embodied as a customization of an existing system, an add-on product, upgraded software, a standalone system, a distributed system, a method, a system, and/or a computer program product. Accordingly, the invention may take the form of an entirely software embodiment, an entirely hardware embodiment, or an embodiment combining aspects of both software and hardware.

### Valuing and Administering an Annuity Account With the GMWB Feature

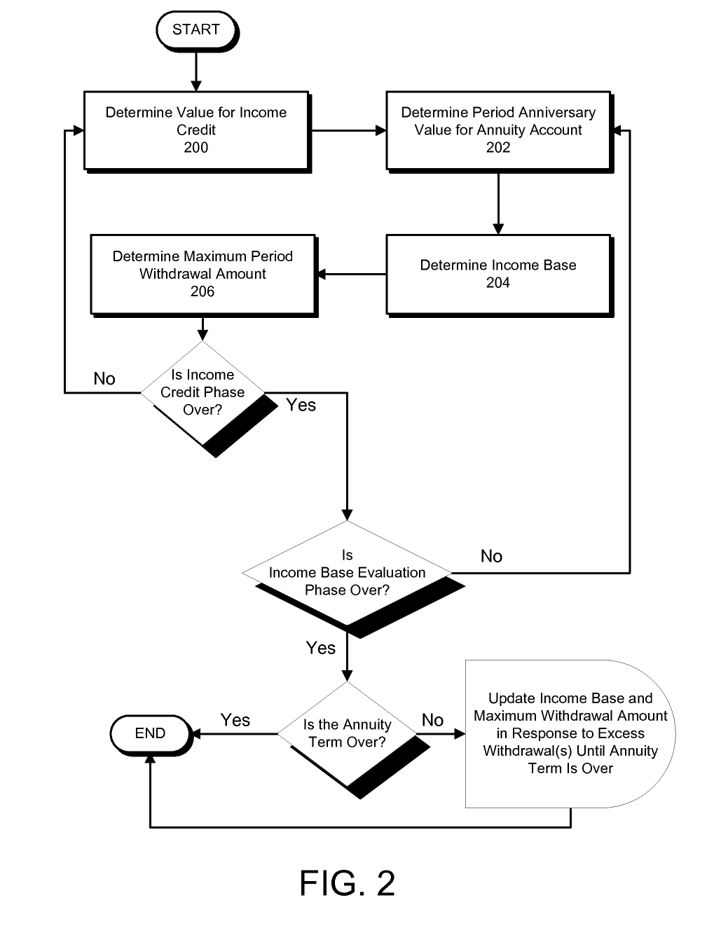

Other aspects of the disclosure relate to a method for valuing and administering an annuity with a guaranteed minimum withdrawal benefit. FIG. 2 is a flowchart illustrating an embodiment of a process for valuing and administering an annuity contract with a GMWB feature as described above. At least one processor can be used to access annuity information in a data storage device and to execute an annuity valuation application using the annuity information.

In a step 200, an Income Credit for the annuity account can be determined. The Income Credit can be an amount equal to a percentage (“Income Credit Percentage”), such as 7%, for example, of an Income Credit Base. The Income Base can be initially equal to the First Eligible Purchase Payment the contract value on the Effective Date if the GMWB feature is elected after contract issue. In each subsequent Benefit Period, the Income Base can be equal to the Income Base at the beginning of the Benefit Period plus any subsequent Eligible Purchase Payments made during that Benefit Period, less proportionate adjustments for Excess Withdrawals that occurred during that Benefit Period.

If the contract owner takes withdrawals in a Benefit Period that are less than or equal to the Maximum Periodic Withdrawal Amount, the Income Credit Percentage on the Benefit Period anniversary can be reduced by a percentage calculated as the sum of all withdrawals taken during the preceding Benefit Period, divided by the Income Base, prior to the determining the Income Base for the next Benefit Period. If the contract owner takes a withdrawal that is greater than the Maximum Periodic Withdrawal Amount in the preceding Benefit Period, the Income Credit can be set equal to zero.

In a step 202, the period anniversary value for the annuity account can be determined. The period Anniversary Value can equal the contract value on any contract period anniversary during the Income Base Evaluation Phase minus any Ineligible Purchase Payments.

In a step 204, the Income Base can be determined. The Income Base can be initially equal to the First Eligible Purchase Payment. If the GMWB feature is elected after contract issue, the initial Income Base can be the contract value on the Effective Date. In each subsequent Benefit Period, the Income Base can be equal to the Income Base at the beginning of the Benefit Period plus any subsequent Eligible Purchase Payments made during that Benefit Period, less proportionate adjustments for Excess Withdrawals that occurred during that Benefit Period. On each Benefit Period anniversary, the administering entity can determine if the Income Base should be increased based on the maximum Anniversary Value or any available Income Credit.

The Maximum Anniversary Value equals the highest Anniversary Value on any Benefit Period anniversary occurring during the Income Base Evaluation Phase. On each Benefit Period anniversary during the Income Base Evaluation Phase, the Income Base can be automatically increased to the Anniversary Value when the Anniversary Value is greater than (a), (b), and (c), where:
(a) is the cumulative Eligible Purchase Payments; and
(b) is the current Income Base, increased by the Income Credit, if any; and
(c) is all previous Anniversary Values during any Income Base Evaluation Period.
   The Income Base will not increase even if the contract value on days other than the Benefit Period anniversary was greater than the Income Base on the Benefit Period anniversary.

On each Benefit Period anniversary during the Income Credit Phase, the amount to which the Income Credit Base and/or the Income Base could increase is determined. The components used to determine this amount are:
(a) the Income Base calculated based on the maximum Anniversary Value; and
(b) the current Income Base plus the Income Credit.

If (a) is greater than or equal to (b), the Income Credit Base and the Income Base are increased to the current Anniversary Value. If (b) is greater than (a), the Income Base is increased by the Income Credit and the Income Credit Base remains unchanged.

In a step 206, the Maximum Periodic Withdrawal Amount can be determined. The Maximum Periodic Withdrawal Amount represents the maximum amount that may be withdrawn each Benefit Period following the Effective Date without reducing the Income Base, and if applicable, the Income Credit Base. The Maximum Periodic Withdrawal Amount can be calculated by multiplying the Income Base by the applicable Maximum Periodic Withdrawal Percentage.

Steps 200, 202, 204, and 206 can be repeated periodically during the Income Credit Phase. Steps 202, 204, and 206 can be performed during the Income Base Evaluation Phase. Step 200 can be omitted when it is the Income Base Evaluation Phase but not the Income Credit Phase. Once the Income Base Evaluation Period is over but before the Annuity Term is over, withdrawals from the annuity account can be monitored to ensure that the total withdrawals in a given period do not exceed the Maximum Periodic Withdrawal Amount. Should there be an Excess Withdrawal, the Income Base and the Maximum Periodic Withdrawal Amount can be updated to reflect the Excess Withdrawal. The annuity account can be monitored until the Annuity Term is completed.

In one arrangement, the annuity valuation application can use the following values:
BB=Benefit base or Income Base
MPWA=Maximum periodic withdrawal amount
CR=Income Credit rate
CB=Credited Base
CA=Credited amount to BB, which is equal to CR×CB
MPW %=Maximum periodic withdrawal percentage
N=Number of years for which the CA is applied
M=Number of years for which increases in account value can be locked in
AV=Anniversary value
MAV=Maximum anniversary value

The following steps can occur during the time prior to the contract owner making a withdrawal:

1. Establish initial values for BB, MPWA, CR, CB, MPW % schedule, N, and M.

2. Report values to the contract owner.

3. Evaluate values periodically (e.g., annually):
a. Determine if new MAV is established. If yes, reset BB=MAV,
b. Calculate CA,
c. Determine if prior BB+CA>MAV. If yes, reset BB=BB+CA, and
d. Calculate new MPWA, which is equal to BB×MPW %

4. Report values to the contract owner.

5. Repeat until withdrawals begin or year M or year N for each component.

The following steps can occur after withdrawals begin:
1. Upon each withdrawal, determine if MPWA is exceeded for the current period. If yes, reset BB=BB×(1−Excess Withdrawal/AV), where the amount the withdrawal exceeds MAWA=Excess Withdrawal, and, if applicable reset CB=CB×(1−Excess Withdrawal/AV).
2. Establish payment program for the contract owner (ad hoc, systematic, EFT); if systematic, update payment amount if BB is reset.
3. Evaluate values periodically:
   a. Determine if new MAV is established. If yes, reset BB=MAV,
   b. Calculate CA,
   c. Determine if prior BB+CA>MAV. If yes, reset BB=BB+CA, and
   d. Calculate new MPWA.
4. Report values to the contract owner.
5. Repeat until AV=0 or year M or year N for each component.

In addition to steps above, the administering entity can establish accounts on an administrative system in the computing environment. The administering entity can send values and guarantees to a reserving engine in the computing environment to set up actuarial reserves for future obligations. The administering entity can send values and guarantees to a risk management system in the computing environment to support hedging activities.

In another embodiment, a method for administering an annuity contract includes storing in a data storage device information about an annuity account of an annuitant. The annuity account has funds allocated to at least one investment. The annuity account has a term including a plurality of time periods, an Income Base, an Income Base Evaluation Phase, an Income Credit Phase, and a Maximum Periodic Withdrawal Amount in a period that may be withdrawn without affecting an Income Base.

At least one processor is used to access the annuity information in the data storage device and to execute an annuity valuation application using the annuity information. The at least one processor is used to modify the annuity information in the data storage device by modifying the existing information in the data storage device based upon information generated by the annuity valuation application or by adding information to the data storage device based upon information generated by the annuity valuation application.

The annuity valuation application sets an initial value for the Income Base and an initial value for an Income Credit Base. The annuity valuation application adjusts the Income Base upward based upon any subsequent Eligible Purchase Payment. The annuity valuation application adjusts the Income Base and the Income Credit Base downward based upon any withdrawal that exceeds the Maximum Periodic Withdrawal Amount in the period. The annuity valuation application periodically determines the anniversary value of the annuity which is equal to the Account Value of the annuity at the end of the period minus any Ineligible Purchase Payments. During the Income Credit Phase, the annuity valuation application periodically determines an Income Credit based upon the Income Credit Base. During the Income Base Evaluation Phase, the annuity valuation application periodically determines the Income Base based upon the Anniversary Value of the annuity and any available Income Credit. The annuity valuation application periodically determines the Maximum Periodic Withdrawal Amount in a period based upon the Income Base.

Updated annuity valuation information generated by the annuity valuation application can be sent to a reserving engine to update actuarial reserves information for future obligations relating to the annuity contract. Updated annuity valuation information generated by the annuity valuation application can also be sent to a risk management engine to support hedging activities relating to future obligations of the annuity contract. A report containing updated annuity valuation information generated by the annuity valuation application can be generated and sent to the contract owner.

In another embodiment, a method for administering an annuity account for the benefit of at least one Covered Person, where the annuity account has an Account Value based on funds allocated to at least one investment and a term including a plurality of periods of time, includes determining an initial Income Base that is independent of the Account Value and determining an initial Income Credit Base.

At least one annuity valuation processor is used to execute a valuation application to determine annuity information for the annuity account. The Income Base is periodically set equal to the greater of (i) a Maximum Anniversary Value and (ii) the current Income Base plus the Income Credit, where the Maximum Anniversary Value is based upon the highest Account Value determined at the end of each period occurring during an Income Base Evaluation Phase and the Income Credit is equal to the current Income Credit Base multiplies by a predetermined percentage. The Income Credit Base is set equal to the Maximum Anniversary Value if the Maximum Anniversary Value is greater than the current Income Base plus the Income Credit. The Income Credit Base is unchanged if the current Income Base plus the Income Credit is greater than the Maximum Anniversary Value. The Maximum Periodic Withdrawal Amount that can be withdrawn in a period without affecting the Income Base is periodically determined. The Maximum Periodic Withdrawal Amount is based upon the Income Base and the age of the youngest Covered Person.

In yet another embodiment, a method for administering an annuity account includes providing at least one processor for executing a valuation application for an annuity account of an annuitant. The annuity account has funds allocated to at least one investment. The annuity account has an accumulation phase with a guarantee for an increased Benefit Base over a period of time and has a guaranteed minimum withdrawal stream for a period of time or for the life of the annuitant.

An annuity account having an owner(s) is established. Data about the annuity account is inputted into a database associated with the at least one processor. The data includes data about at least one of the account owner(s), the investment and election of a guaranteed minimum withdrawal benefit.

The owner(s) is allowed to make withdrawals from the annuity account over a plurality of withdrawal periods of time. For a current withdrawal period, if the amount withdrawn is less than or equal to a specified allowable withdrawal amount, then the amount to be withdrawn in the next withdrawal period is guaranteed to increase in the next withdrawal period by an amount based upon at least one of the age of the owner(s), the amount withdrawn in the current withdrawal period, and a specified crediting rate.

The allowable withdrawal amount is adjusted upwardly based upon an increase in the value of the underlying investment funds. The allowable withdrawal amount is guaranteed to the owner(s) for a specified period of time. If the withdrawal amount(s) in one withdrawal period exceed the allowable withdrawal amount, the allowable withdrawal amount is reduced for the next withdrawal period based upon the excess amount withdrawn.

In yet another embodiment, a method for administering an annuity account with an increasing income stream is used with an annuity account having an Account Value based on funds allocated to at least one investment and a term including a plurality of periods of time. In this embodiment, an initial Income Base is established that is independent of the Account Value. A minimum periodic increase of the Income Base is established. A Maximum Periodic Withdrawal Amount that can be withdrawn in one period without affecting the Income Base is established. An annuity valuation processor is used to execute a valuation application to determine annuity information for the annuity account. In this embodiment, the valuation application periodically increases the Maximum Periodic Withdrawal Amount based upon (i) the Account Value, (ii) the Income Base with the minimum periodic increase of the Income Base applied, or (iii) a predetermined combination of the Account Value and the Income Base with the minimum periodic increase of the Income Base applied.

In other embodiments, a method for valuing and administering an annuity account with a GMWB feature as described above can be provided. The method can use at least one processor to execute an annuity valuation application operably arranged with a database containing information about the annuity account with the GMWB feature. The annuity valuation application can be used to determine values using any of the relationships described above for at least one of the following: Eligible Purchase Payment(s), Ineligible Purchase Payment(s), Income Base, Anniversary Value, Maximum Anniversary Value, Income Credit Base, Income Credit Percentage, Maximum Periodic Withdrawal Amount, Maximum Periodic Withdrawal Percentage, and Administrative Fee.

### Computer-Readable Storage Medium Bearing Instructions for Administering an Annuity Account

The invention may take the form of a computer program product on a computer-readable storage medium having computer-readable program code means embodied in the storage medium. Any suitable computer-readable storage medium can be utilized, including hard disks, CD-ROM, optical storage devices, magnetic storage devices, and/or the like.

In one embodiment, a computer-readable storage medium bears instructions for administering an annuity account of an annuitant. The annuity account has funds allocated to at least one investment. The annuity account has a term including a plurality of periods of time, an Income Base, an Income Base Evaluation Phase, an Income Credit Phase, and a Maximum Periodic Withdrawal Amount in a period that may be withdrawn without affecting an Income Base.

The instructions, when executed by a computer, cause the computer to perform the steps of: setting an initial value for the Income Base, setting an initial value for an Income Credit Base, adjusting the Income Base upward based upon any subsequent Eligible Purchase Payment, adjusting the Income Base and the Income Credit Base downward based upon any withdrawal that exceeds the Maximum Periodic Withdrawal Amount in the period, periodically determining the Anniversary Value of the annuity which is equal to the contract value of the annuity at the end of the period minus any Ineligible Purchase Payments, during the Income Credit Phase, periodically determining an Income Credit based upon the Income Credit Base, during the Income Base Evaluation Phase, periodically determining the Income Base based upon the Anniversary Value of the annuity and any available Income Credit, and periodically determining the Maximum Periodic Withdrawal Amount in a period based upon the Income Base.

In other embodiments, a computer program product for valuing and administering an annuity with a guaranteed minimum withdrawal benefit is provided. In one embodiment, the computer program product comprises a computer-readable storage medium that bears instructions for administering an annuity account of an annuitant. The annuity account has an Account Value based on funds allocated to at least one investment. The annuity account has a term including a plurality of periods of time, an Income Base, a minimum periodic increase of the Income Base, and a Maximum Periodic Withdrawal Amount in one period that may be withdrawn without affecting the Income Base.

In this embodiment, the instructions, when executed by a computer, cause the computer to perform the steps of: setting an initial value for the Income Base; setting an initial value for the minimum periodic increase of the Income Base; setting an initial value for the Maximum Periodic Withdrawal Amount; periodically determining the value of the annuity based upon the Account Value of the annuity at the end of the period; periodically determining the Income Base based upon (i) the periodic value of the annuity, (ii) the Income Base with the minimum periodic increase of the Income Base applied, or (iii) a predetermined combination of the periodic value and the Income Base with the minimum periodic increase of the Income Base applied; and periodically determining the Maximum Periodic Withdrawal Amount based upon the Income Base.

In other embodiments, a computer program product for valuing and administering an annuity with a guaranteed minimum withdrawal benefit can be provided that bears instruction that, when executed by a computer, cause the computer to perform an annuity valuation method as described herein.

### SCOPE OF DISCLOSURE

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for administering an annuity account with an increasing income stream, the annuity account having an account value based on funds allocated to at least one investment and a term including a plurality of periods of time, the method comprising:
establishing an initial income base that is independent of the account value;
establishing a minimum periodic increase of the income base;
establishing a maximum periodic withdrawal amount that can be withdrawn in one period without affecting the income base; and
using an annuity valuation processor to execute a valuation application to determine annuity information
for the annuity account, the valuation application periodically increasing the maximum periodic withdrawal amount based upon (i) the account value, (ii) the income base with the minimum periodic increase of the income base applied, or (iii) a predetermined combination of the account value and the income base with the minimum periodic increase of the income base applied.

2. The method for administering an annuity contract according to claim 1, wherein the valuation application periodically sets the income base equal to the greater of (i) a maximum periodic value and (ii) the current income base plus the minimum periodic increase, where the maximum periodic value is based upon the highest account value determined at the end of each period.

3. The method for administering an annuity contract according to claim 2, wherein the valuation application periodically applies the minimum periodic increase of the income base during an income credit phase.

4. The method for administering an annuity contract according to claim 2, wherein the valuation application periodically sets the income base during an income base evaluation phase.

5. The method for administering an annuity contract according to claim 3, wherein the valuation application periodically sets the income base during an income base evaluation phase.

6. The method for administering an annuity contract according to claim 5, wherein the income credit phase is a different time period than the income base evaluation phase.

7. The method for administering an annuity contract according to claim 2, further comprising:
establishing an income credit base; and
wherein the valuation application periodically sets the minimum periodic increase equal to the income credit base multiplied by a predetermined percentage.

8. The method for administering an annuity contract according to claim 7, wherein the valuation application periodically sets the income credit base equal to the maximum periodic value if the maximum anniversary value is greater than the current income base plus the income credit, and leaves the income credit base unchanged if the current income base plus the income credit is greater than the maximum periodic value.

9. The method for administering an annuity contract according to claim 1, wherein the valuation application periodically sets the maximum periodic withdrawal amount equal to the income base multiplied by a predetermined withdrawal percentage.

10. The method for administering an annuity contract according to claim 1, further comprising:
sending updated annuity valuation information generated by the annuity valuation application to a reserving engine to update actuarial reserves information for future obligations relating to the annuity contract.

11. The method for administering an annuity contract according to claim 1, further comprising:
sending updated annuity valuation information generated by the annuity valuation application to a risk management engine to support hedging activities relating to future obligations of the annuity contract.

12. The method for administering an annuity contract according to claim 1, further comprising:
generating a report containing updated annuity valuation information generated by the annuity valuation application;
sending the report to the annuitant.

13. The method for administering an annuity contract according to claim 1, wherein the annuity contract designates at least one covered person, and the maximum periodic withdrawal amount is guaranteed to the covered person(s) for one of a fixed time period or the lifetime of at least one covered person.

14. The method for administering an annuity contract according to claim 1, wherein the valuation application adjusts the minimum periodic increase based upon a withdrawal taken from the account.

15. A computer-readable storage medium bearing instructions for administering an annuity account of an annuitant, the annuity account having an account value based on funds allocated to at least one investment, the annuity account having a term including a plurality of periods of time, an income base, a minimum periodic increase of the income base, and a maximum periodic withdrawal amount in one period that may be withdrawn without affecting an income base, the instructions, when executed by a computer, cause the computer to perform the steps of:
setting an initial value for the income base;
setting an initial value for the minimum periodic increase of the income base;
setting an initial value for the maximum periodic withdrawal amount;
periodically determining the value of the annuity based upon the account value of the annuity at the end of the period;
periodically determining the income base based upon (i) the periodic value of the annuity, (ii) the income base with the minimum periodic increase of the income base applied, or (iii) a predetermined combination of the periodic value and the income base with the minimum periodic increase of the income base applied; and
periodically determining the maximum periodic withdrawal amount based upon the income base.

16. The computer-readable storage medium bearing instructions for administering an annuity account of an annuitant according to claim 15, wherein the step of periodically determining the income base periodically sets the income base equal to the greater of (i) a maximum periodic value and (ii) the current income base plus the minimum periodic increase, where the maximum periodic value is based upon the highest account value determined at the end of each period.

17. The computer-readable storage medium bearing instructions for administering an annuity account of an annuitant according to claim 15, further comprising:
setting the minimum periodic increase of the income base is based upon at least one of (i) a predetermined amount or (ii) a predetermined amount adjusted based upon a withdrawal taken from the account.

18. A system for administering an annuity contract comprising:
a valuation processor adapted to execute a valuation application for an annuity account of an annuitant, the annuity account having funds allocated to at least one investment, the annuity account having a term including a plurality of periods of time, an account value based upon the value of the funds allocated to at least one investment, an income base for determining a guaranteed benefit, a maximum periodic withdrawal amount in a period that may be withdrawn without affecting the income base, and a minimum periodic increase of the income base; and
a data storage device, the data storage device containing annuity account information, the data storage device operably arranged with the valuation processor such that the annuity account information in the storage device is accessible to the valuation processor and is modifiable by the valuation processor;
wherein the valuation application executed by the valuation processor:
periodically determines the account value of the annuity,
periodically determines the income base using (i) the account value, (ii) the income base with the minimum periodic increase of the income base applied, or (iii) a predetermined combination of the account value and the income base with the minimum periodic increase of the income base applied, and
periodically determines the maximum withdrawal amount in a period based upon the income base.

19. The system according to claim 18, wherein the valuation application periodically sets the income base equal to the greater of (i) a maximum periodic value and (ii) the current income base plus the minimum periodic increase, where the maximum periodic value is based upon the highest account value determined at the end of each period.

20. The system according to claim 18, wherein the minimum periodic increase of the income base is based upon at least one of (i) a predetermined amount or (ii) a predetermined amount adjusted based upon a withdrawal taken from the account

21. The system according to claim 18, further comprising:
at least one input device operatively connected to the valuation processor.

22. The system according to claim 21, further comprising:
at least one output device operatively connected to the valuation processor.

23. The system according to claim 18, further comprising:
an internal network operatively connected to the at least one processor.

24. The system according to claim 18, further comprising:
an external network operatively connected to the at least one processor.
